(19) United States
(12) Patent Application Publication
(10) Pub. No.: US 2006/0001859 A1
(43) Pub. Date: Jan. 5, 2006

(54) Optical sensor

(76) Inventors: Lutz Lohmann, Olching (DE); Rolf Brunner, Eichenau (DE)

Correspondence Address: VENABLE LLP, P.O. BOX 34385, WASHINGTON, DC, 20045-9998, US

(21) Appl. No.: 11/165,588

(22) Filed: Jun. 24, 2005

(30) Foreign Application Priority Data
Jun. 26, 2004 (DE) 10 2004 031 024.6

(51) Int. Cl. G01C 3/08

(52) U.S. Cl. 356/5.06; 356/5.01

(57) ABSTRACT

An optical sensor for detecting objects in an area to be monitored includes a transmitter for emitting light pulses, a receiver for receiving light pulses, and an evaluation unit for determining the distance to an object by means of a transit time for a light pulse to the object. The light pulse is reflected back to the receiver in the form of a receiving light pulse, and the transit time measurement is based on a location in time of a maximum point of the receiving light pulse computed by the evaluation unit.

### CROSS-REFERENCE TO RELATED APPLICATION

This application claims the priority of German Patent Application No. 10 2004 031 024.6-52, filed Jun. 26, 2004, the disclosure of which is incorporated herein by reference.

### BACKGROUND OF THE INVENTION

The invention relates to an optical sensor for detecting the presence of an object in an area to be monitored.

Optical sensors of this type are distance sensors operating based on the transit-time method for which the distance between the object and the optical sensor is computed from the transit time for the light rays, emitted by the transmitter in the optical sensor, to the object and from there back to the receiver.

In the simplest case, optical sensors of this type are used for one-dimensional distance measurements. For these measurements, light rays emitted by the transmitter are emitted in a fixedly predetermined direction, and the area to be monitored is limited to the beam axis region of the transmitted light rays.

According to a different embodiment, optical sensors can be designed as so-called surface distance sensors, wherein an optical sensor of this type is known from German Patent Publication No. DE 19 917 509 C1.

This optical sensor comprises a distance sensor, provided with a transmitter for emitting light rays and a receiver for receiving light rays, as well as an evaluation unit for evaluating the signals received by the receiver and a deflection unit for deflecting the transmitted light rays, so that these sweep periodically across the area to be monitored.

Objects are detected within a defined protective zone. The distance sensor component of this optical sensor preferably operates based on the transit-time principle. The positions of objects within the protective zone can be determined by measuring the distance as well as the continuous detection of the deflection position of the transmitted light rays.

Optical sensors of this type are used in particular also in the area of personal protection. To ensure the protective function of the optical sensor, it should be possible to securely detect objects with varying reflectivity over the total area to be monitored.

As a result of the varying reflectivity of different object surfaces, the receiving signal amplitudes generated in the receiver by the receiving light pulses also vary correspondingly. In particular during the detection of highly reflective objects, the receiver can be overdriven when receiving a light pulse. In that case, the receiving signal amplitude is not proportional to the amplitude for the receiving light pulse. Rather, with an overdriving of the receiver and/or the receiving side components, the receiving signal amplitude is limited to a saturation value even though the amplitude of the receiving light pulse can still increase. The receiver overdrive is maintained even after the receiving light pulse has decayed, so that the receiving signal decays with a corresponding delay as compared to the receiving light pulse. Thus, in the case of receiver overdrive, the amplitude course for the receiving signal no longer corresponds to the amplitude course for the receiving light pulse. In particular, the width of the receiving signal exceeds that of the respective receiving light pulse.

German Publication No. DE 101 43 107 A1 discloses a distance sensor operating based on the transit-time measuring principle, wherein the effects of such receiver overdrive are compensated in order to increase the measuring accuracy of the receiver. For each received light pulse, the width of the recorded receiving signal is thus measured in addition to the actual transit-time measurement. An empirically determined distance correction value is then taken from a correction table for each measured width to correct the result of the realized distance measurement.

### SUMMARY OF THE INVENTION

It is an object of the present invention to provide an optical sensor of the aforementioned type that can be used to realize a precise distance measurement even when detecting objects with varying reflectivity.

The above object and other objects may be met by an optical sensor for detecting objects in an area to be monitored, said sensor comprising: a transmitter for emitting light pulses, a receiver for receiving light pulses, and an evaluation unit for determining the distance to an object by means of a round-trip transit time for a light pulse to and from the object, where the light pulse is reflected back to the receiver in the form of a receiving light pulse, wherein the transit time measurement is based on a location in time of a maximum point of the receiving light pulse. The location in time of the maximum point of the receiving light pulse may be determined in the evaluation unit.

An especially precise distance measurement is ensured, in particular, also in the case of receiver overdrive, if the transit time measurement is relative to the location in time of the maximum point of a receiving light pulse that is received following the transmission of a light pulse.

According to a particularly advantageous embodiment of the invention, the location in time of the maximum point of the receiving light pulse is determined from two stop signals obtained by evaluating the receiving signal generated by the receiving light pulse with a threshold value. In the process, the first stop signal is generated when the receiving signal exceeds the threshold value, and the second stop signal is generated when the receiving signal falls below the threshold value.

Each stop signal ends one transit-time measurement, wherein both transit-time measurements are started by a joint start signal generated by an emitted light pulse. Both transit-time measurements measure the transit time for a light pulse transmitted to an object and reflected back by this object to the receiver, wherein a reference of the measurements to different scanning points of the receiving signal is established by means of the different stop signals.

The location in time of the maximum point for the receiving light pulse can be determined easily by forming a suitable linear combination, meaning by establishing a reference between the transit-time measurement and the location in time of the maximum point, wherein the position (in time) of the maximum point is independent of the amplitude of the receiving light pulse. As a result, the distance measurement is also mostly independent of the amplitude for the receiving light pulses, thus ensuring a precise distance measurement even for objects with strongly varying reflectivity.

The evaluation, according to the invention, of the transit time measurements is based on the finding that for the non-overdriven range, the receiving light pulses, as well as the receiving signals, which are proportional thereto, are essentially symmetrical with respect to the maximum point because the light pulses emitted by the transmitter also show a corresponding symmetry.

By scanning the receiving signal with the same threshold value for generating the stop signals, it is ensured that these stop signals are positioned in time symmetrically with respect to the location in time of the maximum point.

As a result, the distance value can be referenced to the maximum point of the receiving light pulse by forming the arithmetic average of both transit-time measurements.

A reference to the maximum point of the receiving light pulse is also ensured in case of an overdriving of the receiving signal. An empirically determined table of correction values is stored for this in the evaluation unit, in dependence on various differences between the stop signals, and thus the differences in the transit-times for the transit time measurements that are stopped with these stop signals. These correction values take into account the shapes of the distortions of the overdriven receiving signals for the individual transit-time differences, which can be determined, for example, by measuring the receiving signal courses during a teaching process.

The difference between the actually realized transit-time measurements, stopped with the aid of the stop signals, is then determined with the optical sensor operation. Following this, the correction value stored in the evaluation unit for the respective difference is read out and used as a weighting factor to form a weighted average value of both transit-time measurements. Thus, the distance value is again determined in reference to the maximum point of the receiving light pulse.

Since the correction value depends on the difference between the two transit-time measurements, the weighted average value is formed by adding the correction value to the transit time determined during the first transit-time measurement, with reference to the ascending edge of the receiving signal. Alternatively, the correction value is deducted from the transit time determined during the second transit-time measurement.

To distinguish whether or not an overdriven receiving signal is present, the difference between the transit times of both stop signals is compared to a limit value, derived from the width of the respective transmitting light pulse. Since this allows deriving a measure for the width of a non-overdriven receiving light pulse, a secure distinction between overdriven and non-overdriven receiving signals is ensured.

The accuracy of the distance measurement can generally be increased considerably by realizing two or, if applicable, several transit-time measurements for determining the transit time of a light pulse transmitted to an object where it is reflected back to the receiver in the form of a receiving light pulse. One requirement is that the receiving signal scanning points, formed by the respective stop signals, are selected so as to make it possible to determine the position in time of the maximum point for the receiving light pulses.

Various objects of the invention may further be met by a method of performing a distance measurement based on optical signals, comprising: transmitting transmit light pulses; receiving receive light pulses reflected from an object; and determining a distance to said object based on said receive light pulses, said determining comprising finding a location in time of a maximum point of at least one receive light pulse.

### BRIEF DESCRIPTION OF THE DRAWINGS

These and other features and advantages of the invention will be further understood from the following detailed description of the preferred embodiments with reference to the accompanying drawings in which:

FIG. 1 shows a schematic representation of an exemplary embodiment of the optical sensor;

FIG. 2 shows a schematic representation of a protective zone that may be monitored by means of an optical sensor according to FIG. 1;

FIG. 3 shows exemplary time-dependency diagrams for evaluating receiving light pulses in the optical sensor according to FIG. 1 during a trouble-free operation;

FIG. 4 shows the chronological course of a receiving signal that is not overdriven;

FIG. 5 shows the chronological course of non-overdriven receiving signals generated by receiving light pulses, which in turn are generated by objects having varying reflectivity, but which are positioned at the same distance with respect to the device;

FIG. 6 shows the chronological course of an overdriven receiving signal; and

FIG. 7 shows an exemplary implementation of an evaluation unit that may be used in some embodiments of the invention.

### DETAILED DESCRIPTION OF EXEMPLARY EMBODIMENTS

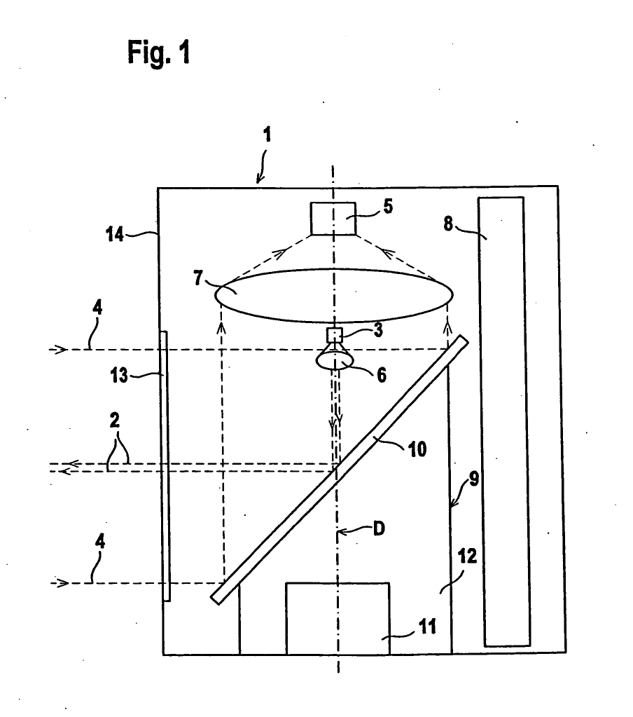

FIG. 1 shows an exemplary embodiment of an optical sensor 1 for detecting objects. The distance sensing element of the optical sensor 1 comprises a transmitter 3 for emitting light rays 2 and a receiver 5 for receiving light rays 4. The transmitter 3 is preferably a laser diode with downstream-positioned transmitting optics 6 for forming a beam with the transmitting light rays 2. The receiver 5 is, for example, a photodiode, with upstream-arranged receiving optics 7.

The distance is measured with the pulse-transit time method, wherein the transmitter 3 emits light rays 2 in the form of short transmitting-light pulses. In the present case, the transmitter 3 emits light pulses with a fixedly predetermined pulse repetition rate. The distance information is obtained by directly measuring the transit time for a light pulse to an object and back to the receiver 5.

The evaluation takes place in an evaluation unit 8 to which the transmitter 3 and the receiver 5 are connected via feed lines that are not shown herein. The evaluation unit 8 for the present embodiment is an application-specific integrated circuit (ASIC).

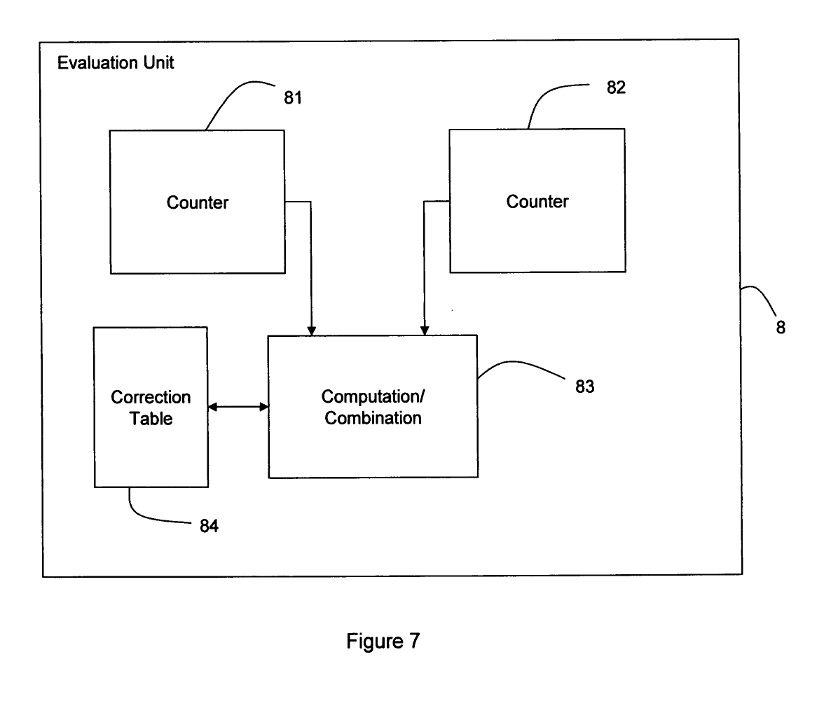

FIG. 7 shows an exemplary implementation of evaluation unit 8 according to some embodiments of the invention. This implementation may be in the form of an ASIC or in the form of separate components. Evaluation unit 8 may contain counters 81 and 82, which may be used, as will be described below, to determine transit times. A computation/combination unit 83 may be used to compute various quantities, which may include a difference between transit time measurements obtained from the two counters 81 and 82. Computation/combination unit 83 may also communicate with a correction table 84 that may be used to store correction values, which may be stored according to values of the difference between the counter outputs. Computation/combination unit 83 may further perform one or more threshold-based evaluations. Computation/combination unit 83 may be a single unit, or it may be comprised of multiple components performing various functions as described below.

The transmitting light rays 2 and the receiving light rays 4 are guided across a deflection unit 9. The deflection unit 9 is provided with a deflection mirror 10, which is fitted onto a revolving mirror holder 12 that is driven by a motor 11. As a result, the deflection mirror 10 rotates with a predetermined speed around a vertical axis of rotation D. The transmitter 3 and the receiver 5 are positioned on the axis of rotation D, above the deflection mirror 10.

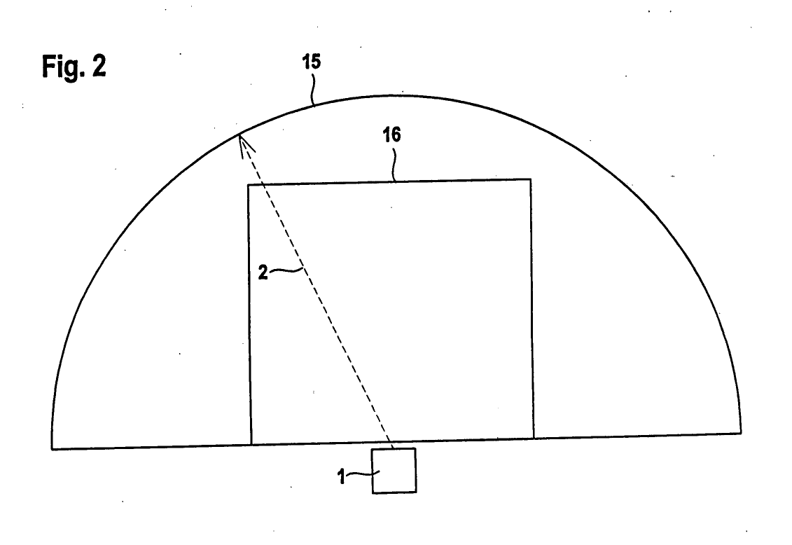

The deflection mirror 10 is tilted at a 45° angle relative to the axis of rotation D, so that the transmitting light rays 2, which are reflected on the deflection mirror 10, are guided horizontally out of the optical sensor 1. In the process, the transmitting light rays 2 pass through an exit window 13 in the front wall of the casing 14 for the optical sensor 1. The casing 14 has a substantially cylindrical shape, wherein the exit window 13 extends over an angular range of 180°. Accordingly, as shown in particular in FIG. 2, the transmitting light rays 2 sweep across an area to be monitored 15 in the form of a semi-circular, level surface in which objects can be detected. The area to be monitored 15 is delimited by the maximal distance that can be detected with the distance sensor element. The receiving light rays 4, which are reflected back by the objects, pass through the exit window 13 while traveling in the horizontal direction and are guided across the deflection mirror 10 to the receiver 5.

To detect the positions of objects, the actual angle position of the deflection unit 9 is detected continuously by means of an angle transmitter, not shown herein, which is connected to the evaluation unit 8. The position of an object is then determined in the evaluation unit 8 from the angle position and the distance value recorded at this angle position.

Optical sensors 1 of this type are used in particular in the field of personal protection, wherein the evaluation unit 8 has a redundant design to meet the safety-technical requirements.

With safety-technical applications of this type, objects and persons are typically not detected within the total area to be monitored 15, scanned by the transmitting light rays 2, but only within a limited protective zone 16, wherein FIG. 2 shows one example for such a protective zone 16. The protective zone 16 in this case is formed by a rectangular, level surface.

A binary object detection signal is generated in the evaluation unit 8, wherein the switching states of this signal indicate whether or not an object is located within the protective zone 16. The object detection signal is emitted via a switching output of the optical sensor 1 which is not shown herein. When used for personal protection, the optical sensor 1, in particular, monitors the area surrounding a machine, wherein the protective zone 16 of the optical sensor 1 covers a danger zone in the area surrounding the machine.

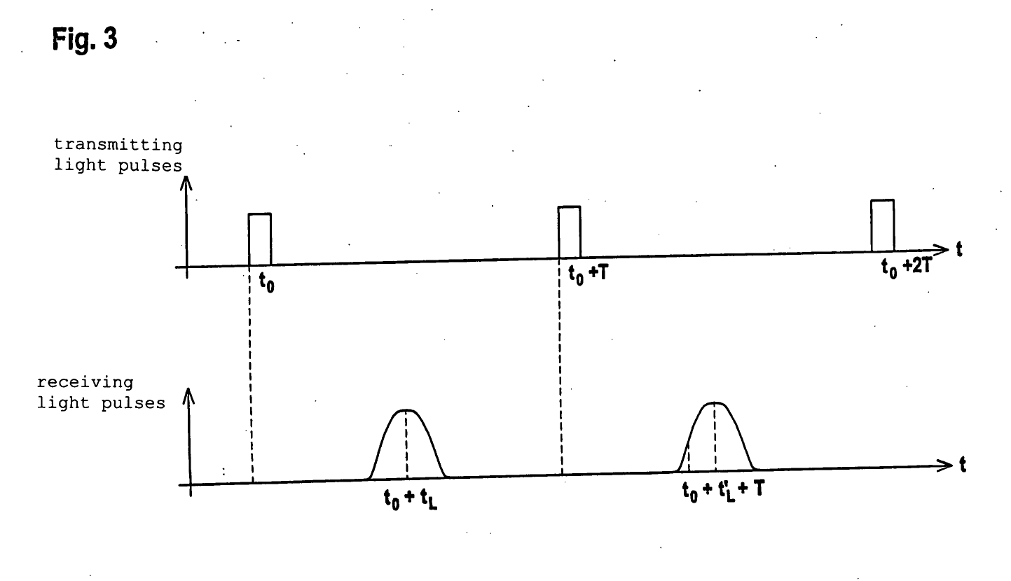

FIG. 3 shows the chronological sequence of the transmitting light pulses and the receiving light pulses during the object detection with the optical sensor 1. The transmitter 3 of the optical sensor 1 emits transmitting light pulses with a predetermined pulse duration and pulse frequency. In the present case, the transmitter 3 emits a sequence of rectangular pulses. In FIG. 3, the cycle length within which, respectively, one transmitting light pulse is emitted by the transmitter 3 is given by the reference T. For object detection, a transmitted light pulse is reflected by the object and travels back to the receiver 5 in the form of a receiving light pulse. Corresponding to the pulse transit time, the receiving light pulse arrives at the receiver 5 with a time delay of t_{L} and/or t_{L′}, as compared to the transmitting light pulse.

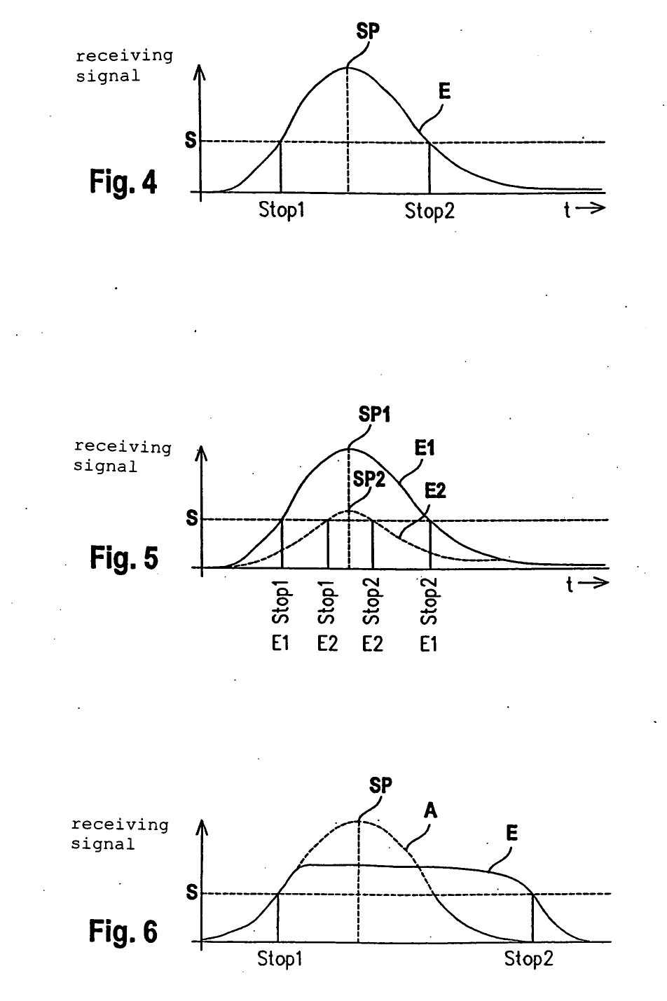

To determine these delay times, which are used to compute the respective object distance in the evaluation unit 8, two transit time measurements are realized for each transmitted light pulse in the case at hand. The measuring principle is shown with the aid of the chronological course illustrated in FIG. 4 for a receiving signal E that is not overdriven. Owing to the fact that the receiver 5 for the present case is not overdriven when receiving a light pulse, the chronological course of the receiving signal E according to FIG. 4 is essentially proportional to the chronological course of the receiving light pulse that is the transmitting light pulse reflected by the object back to the receiver 5. The chronological course of the receiving signal E essentially corresponds to a Gaussian distribution and is mostly symmetrical to the maximum point SP of the distribution.

The two transit-time measurements are started synchronously by means of a START signal, wherein the START signal in the present case is defined by the ascending edge of a transmitting light pulse, shown in FIG. 3. Separate counters may be integrated into the evaluation unit 8, as shown in FIG. 7, for realizing each of the two transit-time measurements, wherein the two counters are started with the START signal, in order to realize the transit-time measurements.

The receiving signal E is evaluated using a threshold value S for generating stop signals STOP1, STOP2, which stop the transit-time measurements. FIG. 4 shows that the first stop signal STOP1 is generated as soon as the receiving signal E exceeds the threshold value S. The stop signal STOP2 is generated as soon as the receiving signal E falls below the threshold value S. As a result of this direction-dependent threshold weighting, the receiving signal E is thus scanned at two scanning points, wherein one scanning point (STOP1) is positioned on the ascending edge of the receiving signal E, and the other scanning point (STOP2) is positioned on the declining edge of the receiving signal E. The stop signal STOP1 ends the first transit-time measurement, while the stop signal STOP2 ends the second transit-time measurement.

To determine the pulse transit time <L> of the receiving light pulse, the arithmetic average of the two transit time values L1, L2, determined by means of the two transit-time measurements, is formed in the evaluation unit 8, using the following equation:
<L>=½(L1+L2).

Since the stop signals STOP1, STOP2 are generated with the aid of a direction-dependent evaluation of the receiving signal using the same threshold value S, these are positioned symmetrically with respect to the maximum point SP of the receiving signal E. As a result of the arithmetic averaging of the transit times, the pulse transit time <L> used for the distance determination is thus relative to the location in time of the maximum point SP of the receiving signal E.

FIG. 5 shows that it is possible to realize a distance measurement that is independent of the receiving signal E amplitude. FIG. 5 also shows the chronological curves for two non-overdriven receiving signals E1, E2, generated by receiving light pulses that are reflected back to the receiver 5 by objects positioned at identical distances to the optical sensor 1, but with differing object reflectivities. The amplitude of the receiving signal E1 in this case is larger than the amplitude for receiving signal E2 because this signal was generated by an object with higher reflectivity. The positions of the maximum points SP1, SP2 for the receiving signals E1, E2 are identical because the receiving signals E1, E2 arrive from objects that are positioned at the same distance to the optical sensor 1.

The distance measuring operation is analogous to the evaluation according to FIG. 4. For the distance measuring, each receiving signal E1, E2 is evaluated with the threshold value S for generating stop signals to end the transit-time measurements. The stop signals STOP1 (E1), STOP2 (E1) for stopping the respective transit-time measurements are obtained in this way for the receiving signal E1. The pulse transit time <L(E1)>, relative to the maximum point SP1 of the receiving signal E1, is determined by forming the arithmetic average on the basis of the herein determined transit times L1(E1), L2(E2). The stop signals STOP1(E2), STOP2(E2) for the receiving signal E2 are determined in the same way, wherein an analogous evaluation is used to determine a pulse transit time <L(E2)> relative to the maximum point SP2. Since the positions of maximum points SP1, SP2 are identical and independent of the amplitudes for the receiving signals E1, E2, the distance measurement is also independent of the receiving signal amplitude.

However, if only one transit-time measurement would be realized for the distance measurement, for example, ending with the stop signals STOP1(E1), STOP2(E2) at the ascending edges, as is the case with known distance sensors, the result of the distance measurement would depend on the amplitudes of the receiving signals E1, E2 because the positions of STOP1(E1), STOP2(E2) depend on the amplitudes of the receiving signals E1, E2, as can be seen immediately from FIG. 5.

FIG. 6 schematically illustrates the chronological course of an overdriven receiving signal E. Such overdriven receiving signals E are generated in particular by highly reflecting objects. The amplitudes of receiving light pulses that are reflected back by such objects are large enough to cause the receiver 5 to be overdriven when receiving these pulses. In that case, the receiving signal E deviates from the ideal course, shown by the reference curve A, and is thus no longer proportional to the amplitude of the receiving light pulse. The overdriven receiving signal E then follows a course where its maximum is cut off once the receiver 5 reaches the saturation level and is limited to a saturation value. Since the overdriving of the receiver 5 decays only with a finite decay time, the receiving signal E is additionally widened considerably.

The overdriven receiving signal E is also evaluated with the threshold value S for generating the stop signals STOP1, STOP2, wherein these two signals are used to end the two transit time measurements, analogous to the embodiment shown in FIG. 4.

In contrast to the evaluation of non-overdriven receiving signals E, the determined transit times L1, L2 are evaluated not by forming an arithmetic average, but by adapting the weighting of the transit times according to the signal form of the receiving signal E.

The duration of the receiving signal E is initially determined in the evaluation unit 8, meaning the difference between the transit times L1, L2 is compared to a limit value, which is derived from the duration of the corresponding transmitting light pulse. If the difference is below the limit value, then the receiving signal E is not overdriven, and the transit times L1, L2 are evaluated in accordance with the embodiment shown in FIG. 4.

However, if the difference is above this limit value, the receiving signal E is overdriven, and the transit times L1, L2 are evaluated specifically for the overdriven receiving signal E.

A correction table is stored in the evaluation unit 8, which contains correction values depending on the various differences between transit times L1, L2, corresponding to the different durations for the overdriven receiving signals E.

This correction table is preferably determined empirically during a learning phase, wherein for highly reflective objects arranged at different distances the courses of overdriven receiving signals E are analyzed in dependence on the chronological courses of the corresponding receiving light pulses.

Alternatively, the transmitter 3 and the receiver 5 can be positioned at a specific distance during the learning phase. A foil is then installed in a predetermined position between transmitter 3 and receiver 5, wherein this foil has a light-permeability ranging from completely transparent to impermeable to light. By displacing the foil, the transmitting light rays 2 are weakened at different rates, thus resulting in varying amplitudes for the receiving signals.

If the optical sensor 1 is operational and an overdriven receiving signal E is present, the corresponding correction value K (L2−L1) is read out of the correction table for the difference between the transit times L1, L2 that are actually determined for the present receiving signal E.

The pulse transit-time for the receiving light pulse is then determined either according to the equation:
<L>=L1+K (L2−L1)
or according to the equation:
<L>=L2−K (L2−L1)

In the first case, the first transit time measurement L₁, which ends with STOP1, is used in addition to the correction value to determine the pulse transit time. In the second case, the second transit time measurement L₂, which ends with STOP2, is used in addition to the correction value to determine the pulse transit time.

Using predetermined correction values ensures that the pulse transit time determination is relative to the location in time of the maximum point SP of the receiving light pulse, meaning to the location in time of the maximum point SP of the ideal signal course A.

It will be understood that the above description of the present invention is susceptible to various modifications, changes and adaptations, and the same are intended to be comprehended within the meaning and range of equivalents of the appended claims.

What is claimed is:

1. An optical sensor for detecting objects in an area to be monitored, said sensor comprising:
a transmitter for emitting light pulses,
a receiver for receiving light pulses, and
an evaluation unit for determining the distance to an object by means of a transit time for a light pulse to the object, where the light pulse is reflected back to the receiver in the form of a receiving light pulse,
wherein the transit time measurement is based on a location in time of a maximum point of the receiving light pulse computed by the evaluation unit.

2. The optical sensor as defined in claim 1, wherein the receiving signal generated by said receiver is evaluated using at least one threshold value, wherein a first stop signal is generated if the receiving signal exceeds the threshold value and a second stop signal is generated if the receiving signal falls below the threshold value.

3. The optical sensor as defined in claim 2, wherein at least one START signal for starting two transit-time measurements is generated when a light pulse is emitted, wherein the first transit-time measurement is ended with the first stop signal and the second transit-time measurement is ended with the second stop signal.

4. The optical sensor as defined in claim 3, further comprising at least one counter, wherein said at least one counter is used to perform the transit-time measurements and is started according to the START signal in the evaluation unit.

5. The optical sensor as defined in claim 4, wherein said at least one counter comprises at least a first counter and a second counter, wherein a respective counter is started in the evaluation unit according to the START signal for each transit-time measurement, and wherein said first counter is stopped with the first stop signal and said second counter is stopped with the second stop signal.

6. The optical sensor as defined in claim 3, wherein said evaluation unit comprises a computation/combination unit to perform a linear combination of two transit times, determined with the transit-time measurements, wherein this linear combination is weighted with a weighting factor for determining a distance value.

7. The optical sensor as defined in claim 6, wherein the weighting factor depends on whether a difference between the transit times exceeds or falls below a predetermined limit value.

8. The optical sensor as defined in claim 7, wherein the limit value is derived from the duration of a transmitting light pulse.

9. The optical sensor as defined in claim 7, wherein the arithmetic average value of both transit times is used for determining the distance value if the difference between the transit times falls below the limit value.

10. The optical sensor as defined in claim 7, wherein one of the two transit times is combined linearly with a correction value for determining the distance value if the difference between the transit times is above the limit value.

11. The optical sensor as defined in claim 10, wherein the linear combination is obtained by forming the sum of the transit time resulting from the first transit-time measurement and the correction value.

12. The optical sensor as defined in claim 10, wherein the linear combination is formed by the difference between the transit time obtained with the second transit-time measurement and the correction value.

13. The optical sensor as defined in claim 10, wherein the correction value depends on the difference between the transit times.

14. The optical sensor as defined in claim 13, wherein said evaluation unit further comprises a correction table to store correction values, wherein the correction values are stored in said correction table according to the difference in the transit times.

15. The optical sensor as defined in claim 14, wherein the linear combination is formed by determining the difference between the transit times for a distance measurement and reading the corresponding correction value out of the correction table.

16. A method of performing a distance measurement based on optical signals, comprising:
transmitting transmit light pulses;
receiving receive light pulses reflected from an object; and
determining a distance to said object based on said receive light pulses, said determining comprising finding a location in time of a maximum point of at least one receive light pulse.

17. The method according to claim 16, wherein said finding a location in time comprises:
applying a threshold value to said at least one receive light pulse to obtain at least first and second stopping points corresponding, respectively, to points in time at which said at least one receive light pulse crosses said threshold value in an ascending direction and crosses said threshold value in a descending direction.

18. The method according to claim 17, wherein said finding a location in time further comprises:
measuring a first transit time and a second transit time, respectively, to each of said first and second stopping times beginning from a starting time, said starting time being determined based on a transmit time of at least one transmit light pulse corresponding to said at least one receive light pulse.

19. The method according to claim 18, wherein said finding a location in time further comprises:
obtaining a linear combination of said first transit time and said second transit time, wherein said linear combination is used to obtain said distance measurement.

20. The method according to claim 19, wherein said obtaining a linear combination comprises:
taking a difference between said first and second transit times; and
comparing said difference with a limit value determined based on a duration of a transmit light pulse.

21. The method according to claim 20, wherein said obtaining a linear combination further comprises:
determining the arithmetic average of said first and second transit times if said difference is less than said limit value; and
combining either said first transit time or said second transit time with a correction value based on said difference if said difference is above said limit value.
